(19) United States
(12) Patent Application Publication
(10) Pub. No.: US 2016/0224680 A1
(43) Pub. Date: Aug. 4, 2016

(54) Imaging Device for Scan-To-Mobile Computing Device

(71) Applicant: LEXMARK INTERNATIONAL, INC., Lexington, KY (US)

(72) Inventors: Charles Mark Maynard, II, Lexington, KY (US); Jeffrey Lee Richards, Versailles, KY (US)

(21) Appl. No.: 14/609,616

(22) Filed: Jan. 30, 2015

(51) Int. Cl. G06F 17/30; G06K 7/14; G06K 19/06

(52) U.S. Cl. CPC G06F 17/30879; G06F 17/30887; G06F 17/30011; G06K 19/06112; G06K 19/06037; G06K 7/1417

(57) ABSTRACT

Users seek to obtain documents on their mobile computing device, such as a smart phone or tablet. Their device has a quick response (QR) code reader application and a camera for capturing QR codes. An imaging device scans the document and transfers its image to a remote computing device, such as a server, for storage. The remote device returns to the imaging device a uniform resource locator (URL) and unique identifier corresponding to the image. The imaging device displays to the user a QR code corresponding to the URL and unique identifier. The user captures the QR code with the camera of their mobile device and the QR code reader application launches a browser. The image is requested to be transferred to the mobile computing device. Upon return of the image from the remote computing device, the image of the document is displayed to the user.

### FIELD OF THE INVENTION

The present invention relates to imaging devices, such as printers and copiers, and mobile computing devices, such as smart phones and tablets. It relates also to scanning documents on imaging devices for easy viewing and manipulation on mobile computing devices. Computing applications, computing environments, systems, software, interfaces, methods and apparatus typify the embodiments.

### BACKGROUND

Modern offices tend to use less paper documents in favor of digital documents. Among some reasons, digital documents require less expense to procure and replicate as they avoid the expense of ink, toner and paper. Their storage on hard drives, servers, etc. occupies much less physical space as compared to file rooms of cabinets, shelves, folders and boxes. They are also generally easier to file away and search for when needed and easier and cheaper to send to third parties, such as with attachments to email. Users often tote with them digital documents on their mobile computing devices for ready viewing and manipulation when away from office laptops and desktops.

Transferring paper documents to mobile computing devices, however, remains cumbersome. In some instances, users scan documents on imaging devices, such as printers or copiers, and then email digital images as attachments to one or more email addresses. They view the images on their mobile device by accessing their email accounts, selecting the appropriate email and opening the attachment with a suitable attachment reader or viewer. While sufficient for getting images to mobile devices, the foregoing requires many manual steps by the user and often requires manually typing email addresses on the imaging device which can be mistyped. In other instances, users take pictures of paper documents with a camera integrated on their mobile computing device. While also sufficient for obtaining images on mobile phones and tablets, the picture-taking approach becomes tedious when capturing large documents having many pages each requiring a picture and becomes impractical for delivery to more than one mobile device in need of the document. Capturing images with a camera on a mobile device also subjects images to distortion that is less likely with a flatbed scanner integrated on an imaging device as users sometimes skew their field of view when focusing on documents or shake their devices when activating a camera button. Image capture with a camera on a mobile device is also slow when compared to an automatic document feeder on an imaging device.

A need exists in the art to better facilitate transfer of hard copy documents onto mobile computing devices. The inventors have identified a further need that involves utilizing the scanner and sheet-feeder hardware of imaging devices, but without needing custom software from third parties. Additional benefits and alternatives are also sought when devising solutions.

### SUMMARY

The above-mentioned and other problems are solved by imaging devices having scan-to-mobile-computing-devices. A user seeks to obtain a document on their mobile computing device, such as a smart phone or tablet. Their device has a quick response (QR) code reader application and a camera for capturing QR codes. An imaging device scans the document and transfers its image to a remote computing device, such as a server, for storage. The remote device returns to the imaging device a uniform resource locator (URL) and unique identifier corresponding to the image. The imaging device displays to the user a QR code corresponding to the URL and unique identifier. The user captures the QR code with the camera of their mobile device and the QR code reader application launches a browser, in turn requesting the image transfer to the mobile computing device. Upon return of the image from the remote computing device, the image of the document is available for display to the user and its ready manipulation thereof. In this way, users no longer need to obtain documents on their mobile devices by accessing email attachments, typing in URL addresses which can be often lengthy and tedious, taking photos of documents page-by-page to capture whole documents, or the like. Various embodiments contemplate techniques for sharing the document with multiple users each with their own mobile computing device, such as those attending a conference. Software, executable code, interfaces, computing system environments, methods, and apparatus typify the embodiments. For security, images can be encrypted and securely transmitted. Decryption occurs with suitable keys. Pins, passwords, badges, logins, and other features can be used for user authentication.

These and other embodiments are set forth in the description below. Their advantages and features will become readily apparent to skilled artisans. The claims set forth particular limitations.

### BRIEF DESCRIPTION OF THE DRAWINGS

FIG. 1 is a diagrammatic view of a computing system environment according to the prior art for configuring a mobile computing device with a quick response (QR) code reader application;

FIGS. 2A-2C are stepwise diagrammatic views according to the present embodiments for obtaining images of hard copy documents on a mobile computing device; and

FIGS. 3A and 3B are diagrammatic views according to the present embodiments for proliferating QR codes on mobile computing devices of multiple users to directly obtain images thereon.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, imaging devices have computing applications facilitating transfer of images direct to mobile computing devices.

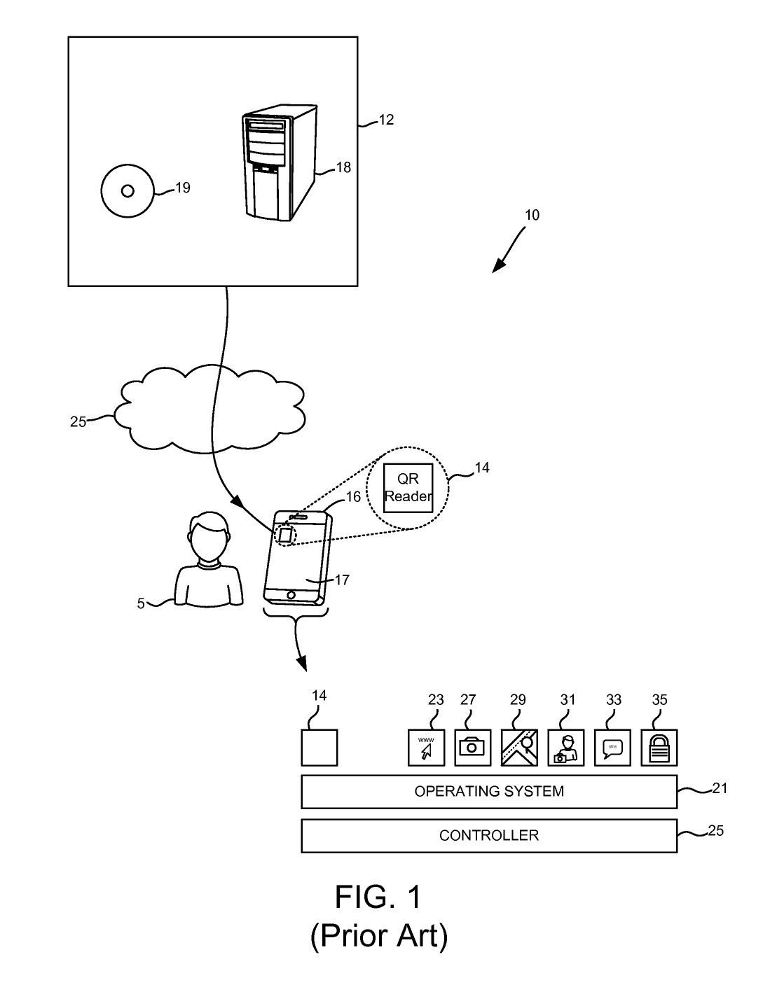

With reference to FIG. 1, users 5 need a quick response (QR) code reader 14 on their mobile computing device 16, e.g., smart phone, tablet, etc. To obtain the reader, a computing system environment 10 includes a service provider 12 of mobile applications (colloquially “mobile ‘apps’”), as is familiar. The provider makes available the applications that users download onto their device. The download resides as executable code on a computing device 18 such as a server or imprinted on a computer readable medium 19 such as a CD, smart card, USB stick, etc. Users retrieve the medium and load the application directly onto their mobile device or with assistance from still another computing device (not shown). Alternatively, users execute a series of functions on their mobile device and obtain the requisite code by way of an attendant computing network 25. The network includes or not a variety of software such as an “app store” and hardware such as routers, servers, switches, desktop/laptop computers, phone transmission towers, satellites, etc. The connections typify wired and wireless communications between a few or many devices in an internet, intranet or other environment. Skilled artisans readily understand the process and the requisite actions for downloading applications.

Upon successful receipt of the application 14, the mobile computing device 16 hosts it on one or more controllers 20 resident in a housing 17. The controller(s) also host an operating system 21 and one or more additional mobile applications, as is typical. The additional applications also have functionality that can be accessed, opened or otherwise utilized by the QR reader application 14. These include, for example, a web browser 23, camera 27, map or GPS device 29, photo album 31, SMS 33, and security module for encryption un/lock 35. Their functionality is known in the art.

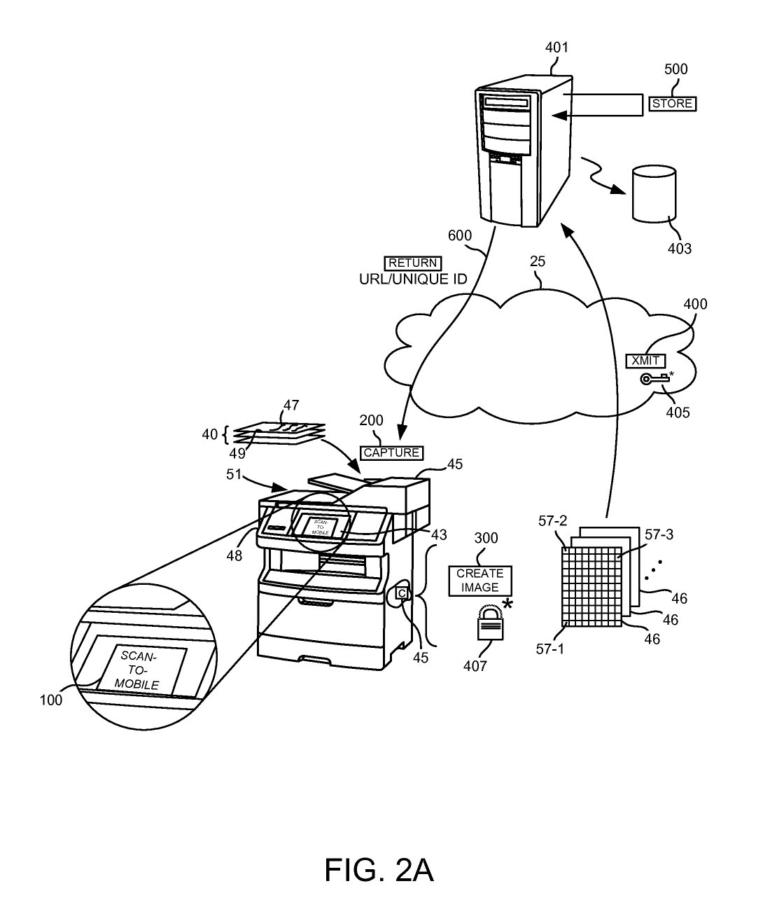

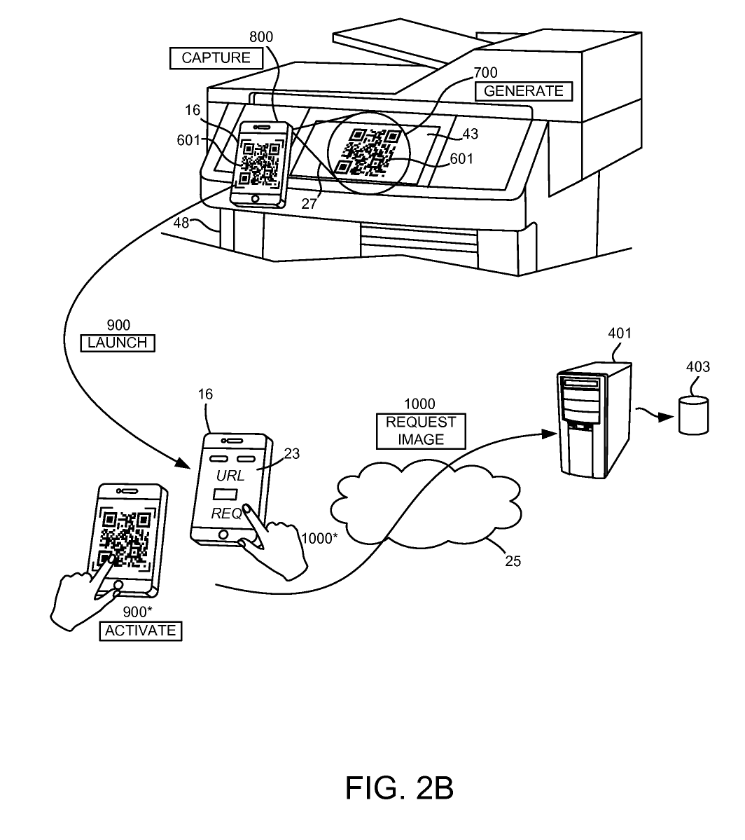

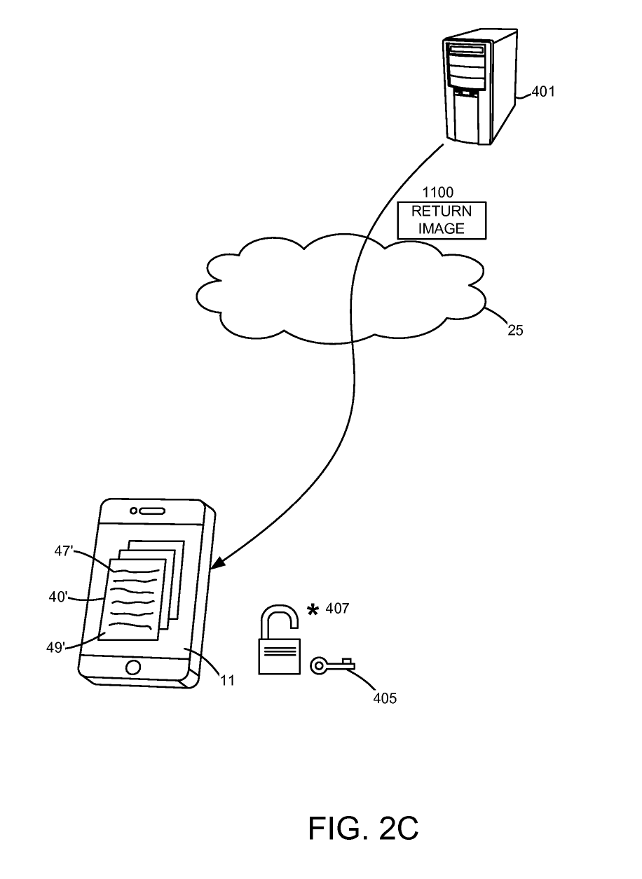

With reference to FIG. 2A, users seek to transfer to their mobile computing device an image corresponding to hard copy input document(s) 40. The document(s) are any of a variety, but commonly hard copies in the form of letters, papers, invoices, receipts, business cards, books, etc. They contain text, graphics, or other information 47 and/or background 49. The text typifies words, numbers, symbols, phrases, etc. having content relating to the topic of the document. The background represents the underlying media on which the content appears. The background can also include various colors, advertisements, corporate logos, watermarks, textures, creases, speckles, stray marks, row/column lines, and the like.

Regardless of type, a user begins the process of getting document(s) 40 to their mobile computing device by initiating an application on an imaging device 48, such as scan-to-mobile 100. A user interface 43 displays the application to the user and the user selects it, such as by pressing the application. The application is hosted in executable code on a controller 45 of the imaging device. The controller typifies one or more (micro)processors, ASICs, circuits, etc. At 200, the user feeds the document(s) to the imaging device for capture by the controller. This includes placing the document(s) direct on a scanner 51 of the imaging device or placing them in an automatic document feeder 45, as is familiar, and executing a scanning operation of the imaging device.

From there, the document(s) 40 have digital images 46 created 300 by the controller that correspond in digital format to the information, graphics, etc. of the document(s). Alternatively, the digital images are created at a computing device (not shown), such as a laptop, desktop, tablet, smart phone, etc. that are sent to the imaging device 48. In either, the image 46 typifies a grayscale, color or other multi-valued image having pluralities of pixels 57-1, 57-2, 57-3, . . . . The pixels define text and background of the document(s) 40 according to their pixel value intensities. The quantities of pixels in the images are many and depend upon the resolution of the scan at the capture 100, e.g., 150 dpi, 300 dpi, 1200 dpi, etc. Each pixel also has an intensity value defined according to various scales, but a range of 256 possible values is common, e.g., 0-255. The pixels may be also in binary form (black or white, 1 or 0) after conversion from other values or as a result of image creation at 300. In many schemes, binary creation occurs by splitting in half the intensity scale of the pixels (0-255) and labeling as black pixels those with relatively dark intensities and white pixels those with light intensities, e.g., pixels 57 having intensities ranging from 0-127 become labeled black, while those with intensities from 128-255 become labeled white. Other schemes are also possible. That the document capture function sometimes results in imperfections in the document(s), such as rotation, skew, wrinkle, etc., and/or that differing document(s) might have differing resolutions or bit-depth, the controller 25 is often outfitted with executable instructions to overcome these imperfections and optimize the images.

Next, the images in their digital form are transferred 400 from the imaging device 48 to a remote computing device 401, such as a computing server. The remote computing device stores the images 500 on a local or remote volume 403. Artisans will appreciate that imaging devices 48 are normally configured for printing, copying, emailing, faxing, etc., but are not typically configured with a large-enough storage volume to locally maintain multiple images of multiple documents thereon, thus transmission and storage of the images to the remote computing device. Artisans will also appreciate that the transmitting of the images can occur in a secure manner, such as by encrypting the images 407 and transmitting requisite keys 405 for unlocking them. The encryption and keys can be adopted from any well known or other scheme.

Upon receipt of the images for storage at 500, the remote computing device generates a unique identifier corresponding to the location of the stored images and a URL for accessing them over a computing network 25. The unique identifier and URL is returned to the imaging device 48 at 600.

With reference to FIGS. 2B and 2C, the URL and unique identifier are embedded into a QR code 601 and such is displayed to the user on the user interface 43. The QR code is either generated 700 at the imaging device in functionality of the controller 45 or is generated at the remote computing device and pushed to the imaging device upon returning of the URL and unique identifier at 600. Of course, the generation of QR codes from data is well known in the art and is often advertised under the label “QR code generators,” generally available via the internet.

At 800, the user of the mobile computing device 16 utilizes the camera function 27 and captures thereon the QR code 601. Within the functionality of the QR reader application 14 already installed for operation on the mobile computing device (FIG. 1), the QR reader automatically opens the browser function 23 of the mobile device and launches redirection of the browser at 900 to the URL embedded in the QR code. Alternatively, the QR reader application requires URL redirection upon manual activation by a user 900*. From there, the images stored 403 by the remote computing device 401 become automatically requested 1000 (or by manual manipulation by the user 1000*) for return 1100 to the mobile computing device. Once at the mobile computing device, the images are available for viewing and manipulation on the display 11 by the user of the mobile computing device as is typical. In this way, the user now has quick access to image(s) 40′ corresponding to the original hard copy document(s) 40, but without extensive interaction to obtain the images on their mobile device, such as occurs with emailing document(s), uniquely taking pictures of each page of document(s), typing in URL's, typing in email addresses, etc. Decryption *407 of the images may be also required if such were securely transmitted to the mobile computing device. For added security, a pin or other manual entry technique could be required of the user to access the images. The pin can be generated and displayed to the user as part of their capture of the QR code at 800.

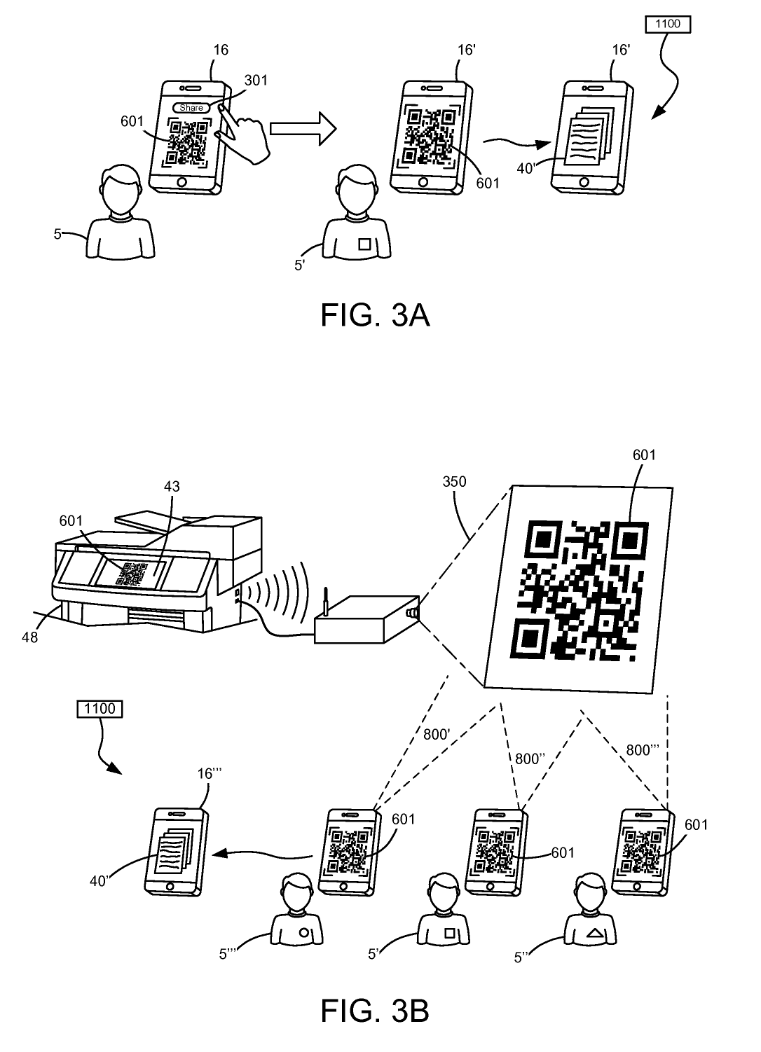

With reference to FIGS. 3A and 3B, the foregoing enables easy proliferation and dissemination of the original document(s) to multiple users each equipped with their own mobile computing devices having QR reader applications. In one instance, the QR code 601 can be shared 301 from one mobile computing device 16 to another 16′, in turn, retrieving the relevant images 1100 from the remote computing device for display, FIG. 3A. The sharing can occurring within functionality of the QR reader application or can occur such as by texting a picture of the QR code from the mobile computing device of the first user 5 to a second user 5′. A picture of the QR code can be captured by the camera of the mobile device and shared from the photo album function 31 (FIG. 1). In another instance, multiple users can each capture 800′, 800″, 800″′ their own QR code 601 direct from the user interface 43 of the imaging device 48 or from a common projection 350 or display of the QR code in communication with the imaging device. In turn, the return 1100 of the images 40′ from the remote computing device occurs to each mobile computing device 16 for each of the users 5 (only showed for user 5″′ on their mobile device 16″′).

Relative advantages of the many embodiments should now be apparent to those skilled in the art. They include but are not limited to: (1) facilitating easy placement of images of documents on a mobile device; (2) leveraging hardware functionality of flatbed scanners and sheet-feeders of imaging devices; (3) quickly placing images on devices with minimal steps; and (4) quick proliferation of the images on multiple mobile devices, without unnecessary tasks of emailing, typing, texting, etc.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments.

1. An imaging device configured for communication with a remote computing device, comprising:
a scanner for receiving and scanning hard copy input documents;
a controller in communication with the scanner for converting into digital images the hard copy input documents;
an application installed for operation on the controller; and
a user interface for a user to select for execution the application, the controller configured to send the digital images to the remote computing device and to receive back from the remote computing device a uniform resource locator and unique identifier corresponding to the digital images, wherein upon said receiving back the uniform resource locator and unique identifier from the remote computing device the controller causes for display on the user interface a quick response code that can be captured by a mobile computing device, the quick response code on the mobile computing device facilitating retrieval of the digital images on a display thereof.

2. The imaging device of claim 1, wherein the controller is further configured to locally generate the quick response code.

3. The imaging device of claim 1, wherein the controller is configured to receive the quick response code from the remote computing device.

4. The imaging device of claim 1, wherein the quick response code includes the uniform resource locater and unique identifier therein.

5. A system for digitally obtaining images of hard copy documents on a mobile computing device, comprising:
a server;
an imaging device, the imaging device having
a scanner for receiving and scanning hard copy input documents,
a controller in communication with the scanner for converting into digital images the hard copy input documents,
an application installed for operation on the controller, and
a user interface for a user to select for execution the application; and
a mobile computing device having a camera, the controller configured to send the digital images to the remote computing device and to receive back from the remote computing device a uniform resource locator and unique identifier corresponding to the digital images, wherein upon said receiving back the uniform resource locator and unique identifier from the remote computing device the controller causes for display on the user interface a quick response code that can be captured by the camera of the mobile computing device, the quick response code on the mobile computing device facilitating retrieval of the digital images on a display thereof.

6. The system of claim 5, wherein the controller is configured to encrypt the digital images.

7. The system of claim 5, wherein the mobile computing device is a smart phone.

8. The system of claim 5, further including a quick response code reader application installed on an operating system of the mobile computing device.

9. The system of claim 5, further including a decryption key on the mobile computing device to unlock any decrypted images.

10. A method for obtaining images of hard copy documents on a mobile computing device, comprising:
scanning one or more input documents on an imaging device;
creating one or more digital images from the one or more input documents;
transferring the one or more digital images from the imaging device to a remote computing device;
in response to the transferring, receiving from the remote computing device a uniform resource locator and a unique identifier corresponding to the one or more digital images; and
displaying a quick response code on a user interface of the imaging device for the mobile computing device to capture thereon, the quick response code corresponding to the uniform resource locator and the unique identifier.

11. The method of claim 10, further including launching a web browser on the mobile computing device upon the capture of the quick response code on the mobile computing device.

12. The method of claim 10, further including transferring the one or more digital images from the remote computing device to the mobile computing device after the launching the web browser.

13. The method of claim 12, further including displaying the digital images on the mobile computing device.

14. The method of claim 10, further including generating the quick response code by a controller of the imaging device.

15. The method of claim 10, further including receiving at the imaging device the quick response code from the remote computing device.

16. The method of claim 10, further including installing a quick response code reader application on the mobile computing device.

17. The method of claim 10, further including encrypting the one or more digital images on the imaging device before the transferring to the remote computing device.

18. The method of claim 17, further including decrypting the one or more digital images at the mobile computing device.

19. The method of claim 10, further including storing the one or more digital images upon the transferring thereof from the imaging device to the remote computing device.

20. The method of claim 10, further including capturing the quick response code by the mobile computing device.
